(19) United States
(12) Patent Application Publication
(10) Pub. No.: US 2023/0174240 A1
(43) Pub. Date: Jun. 8, 2023

(54) MOBILE THERMAL ENERGY STORAGE

(71) Applicant: Nostromo Ltd., Even-Yehuda (IL)

(72) Inventors: Ziv SHEFER, Rehovot (IL); Ori ASSCHER, Tel Aviv (IL); Yaron BEN NUN, Even-Yehuda (IL)

(21) Appl. No.: 18/075,793

(22) Filed: Dec. 6, 2022

Related U.S. Application Data
(60) Provisional application No. 63/286,148, filed on Dec. 6, 2021.

(51) Int. Cl. B64D 13/08; F28D 20/00

(52) U.S. Cl. CPC B64D 13/08; F28D 20/00; F28D 2020/0021; F28D 2020/0026; F28D 2020/0069

(57) ABSTRACT

Supplying thermal energy to a consumer, such as a parked vehicle, e.g., a parked aircraft, while reducing carbon emission and expenditure on electricity, by charging an energy storage unit at a first location to obtain a charged energy unit, and then mobilizing the charged energy storage unit from the first location to a location of a consumer, where the charged energy storage unit can then be connected to the consumer and can be discharged at the location of the consumer, providing the consumer with thermal energy.

### FIELD

The present invention relates to the field of thermal energy storage.

### BACKGROUND

Air conditioners (AC) are typically used to provide a comfortable interior environment to enclosed spaces such as buildings and vehicles. While buildings are usually connected to an electrical grid or other high-power source for powering air conditioners, vehicles such as trains, cars or aircrafts typically use fuel-based engines to provide power for air conditioning.

There is a high demand for air conditioning especially in commercial transportation vehicles (such as trains, buses and airplanes) which may hold a large number of people, and which may have long periods of parking outdoors, exposed to the climate in the environment. Parked aircrafts typically use power for air conditioning from an emergency power unit, which is a turbine engine installed in the aircraft and which is typically used as an alternate or emergency hydraulic or electrical power source.

It has been suggested to use mobile or portable AC systems for climate conditioning in parked aircrafts. These systems include an air conditioner, that can be mobilized to a location close to an aircraft and can provide cooled (or heated) air directly to the aircraft cabin, thereby reducing losses while cooling/heating. Also, the number of wires and tubes lying on the ground near the aircraft can be reduced by bringing the air handling unit closer to the aircraft. Unfortunately, these systems typically use a fuel-based internal combustion engine which is a low efficiency and high emission device. Alternatively, the portable AC system may be connected to the electrical grid, typically to a power point in an airport terminal building thus creating a heavy burden on the terminal's electricity grid and limiting their range of operation to vicinity of a power point.

Providing air conditioning to parked commercial aircrafts at airports is a never ending, high-power demand task that places great pressure on the already sensitive chain of supply and service providers at the airport. Unfortunately, the existing AC solutions for parked aircrafts struggle to supply the high power output required for air conditioning an aircraft cabin full of people (who generate heat in addition to the climate). The existing solutions are not only inadequate; they are also heavily polluting and do not enable efficient energy management at airports.

### SUMMARY

Embodiments of the invention provide a mobile energy storage system that can provide thermal energy to a consumer, e.g., a parked aircraft. Mobile energy storage systems according to embodiments of the invention, can supply thermal energy at any desired location and at a high-power output rate that can satisfy the high cooling demands of parked aircrafts, without requiring a connection to the electrical grid or other high-power source and without relying on a high emission engine.

Thus, systems and methods according to embodiments of the invention provide flexible, low-cost and nonpolluting solutions for air conditioning of parked aircrafts, contributing to decarbonization of the commercial airline sector and to efficient energy management at airports.

In one embodiment a mobile energy storage system includes a thermal energy storage unit, an inlet through which to connect the storage unit to a charging station, during a charging stage, and an outlet by which to connect the storage unit to a consumer, during a discharging stage. The system includes a mobilization apparatus configured to enable mobilization of the storage unit between the charging station and the consumer. The system is typically mobilized while the storage unit is not connected to the charging station or to the consumer.

The mobile energy storage system may include a fluid distribution system to introduce a heat transfer fluid (HTF) into the storage unit, circulate the HTF through the storage unit and move the HTF out of the storage unit. The fluid distribution system can introduce cooled HTF via the inlet to circulate through the storage unit to charge the storage unit with thermal energy, and may circulate HTF through a charged storage unit to discharge the storage unit, thereby cooling the HTF. For example, charging the storage unit can be done by circulating HTF over phase change material (PCM) containing capsules that are contained within the energy storage unit, the HTF being at a temperature below PCM freezing temperature. Such a low temperature HTF will cause the PCM to freeze, thereby storing thermal energy. Discharging the storage unit may be done by circulating HTF which is at a temperature above PCM freezing temperature, over frozen PCM containing capsules. The frozen PCM containing capsules will cool the HTF, thereby discharging the storage unit, releasing stored thermal energy.

Systems according to embodiments of the invention may include a heat exchanger to accept cooled HTF from the storage unit, to cool air using the cooled HTF, and to output the cooled air. The system may include a tube by which to transport the cooled air from the outlet to the consumer.

A method for supplying thermal energy to a consumer, according to embodiments of the invention includes charging a thermal energy storage unit at a first location, to obtain a charged storage unit, mobilizing the charged storage unit from the first location to a location of a consumer fluidly connecting the charged storage unit to the consumer and discharging the charged storage unit at the location of the consumer, providing the consumer with thermal energy. The storage unit can be connected to a charging station at the first location for charging the storage unit. The storage unit is typically disconnected from the charging station before being mobilized.

The first location, where the storage unit is charged, may be in proximity to a source of cooled HTF. Charging the energy storage unit can be done by circulating HTF cooled at the first location through the energy storage unit and discharging the energy storage unit can be done by circulating HTF through the charged energy storage unit, at the location of the consumer.

As further described herein, one example of charging the storage unit is by circulating HTF over PCM containing capsules within the energy storage unit, (the HTF being at a temperature below PCM freezing temperature), to cause the PCM to freeze. Discharging the storage unit can be done by circulating HTF which is at a temperature above PCM freezing temperature, over the frozen PCM containing capsules, to cool the HTF.

As further detailed below, embodiments of the invention enable charging the storage unit during a window of time determined by airport service providers and discharging the storage unit during a window of time determined by airport authorities. Thus, embodiments of the invention can ease the pressure off the airport supply chain and can enable efficient energy management, taking into account specific loads of the airport.

### BRIEF DESCRIPTION OF THE DRAWINGS

The invention will now be described in relation to certain examples and embodiments with reference to the following illustrative drawing figures so that it may be more fully understood. In the drawings:

FIG. 1A schematically illustrates a mobile energy storage system operable according to embodiments of the invention;

FIGS. 1B-1D schematically illustrate a side view, front view and back view of a mobile energy storage system, according to embodiments of the invention;

FIG. 2 schematically illustrates an energy storage apparatus, according to embodiments of the invention

FIGS. 3A-B schematically illustrate energy storage units, according to embodiments of the invention;

FIG. 4 schematically illustrates a mobile energy storage system connected to a parked vehicle, according to embodiments of the invention;

FIG. 5 schematically illustrates a mobile energy storage system being charged, according to embodiments of the invention; and

FIG. 6 is a flow chart schematically illustrating a method for providing thermal energy to a consumer, according to embodiments of the invention.

### DETAILED DESCRIPTION

Embodiments of the invention provide systems that can store thermal energy and release the stored thermal energy at any desired location to provide cold-type energy or heating to a consumer, even if the consumer is not near a power point. Additional embodiments of the invention provide methods for supplying thermal energy to a consumer while reducing carbon footprint and expenditure.

The consumer may be a parked vehicle, such as a train carriage, a bus or an aircraft. In other embodiments, the consumer may be a construction such as an enclosed passage, e.g., a bridge or a walkway for boarding a vehicle such as a ship or an airplane.

The embodiments exemplified herein refer mainly to providing cold-type energy to a consumer but can also be used to provide heat.

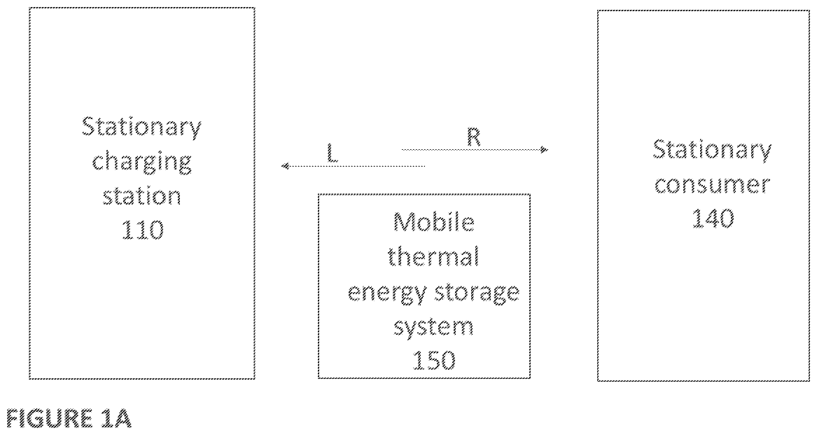

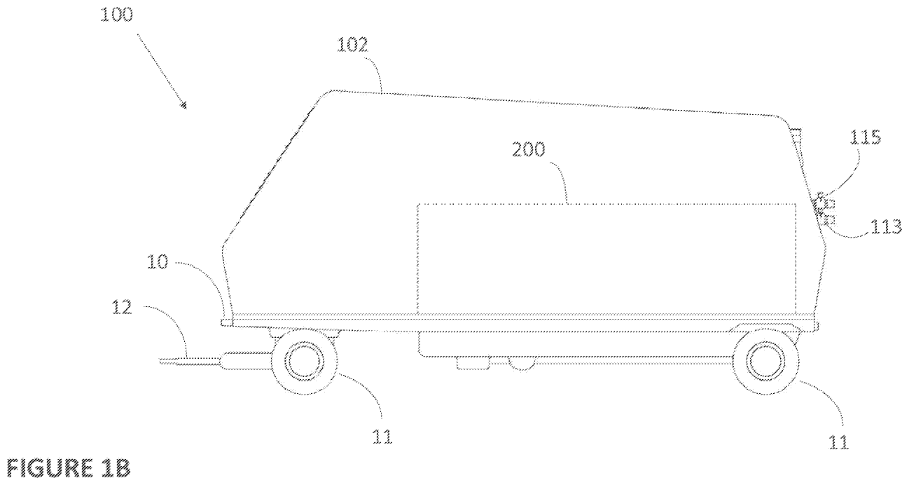

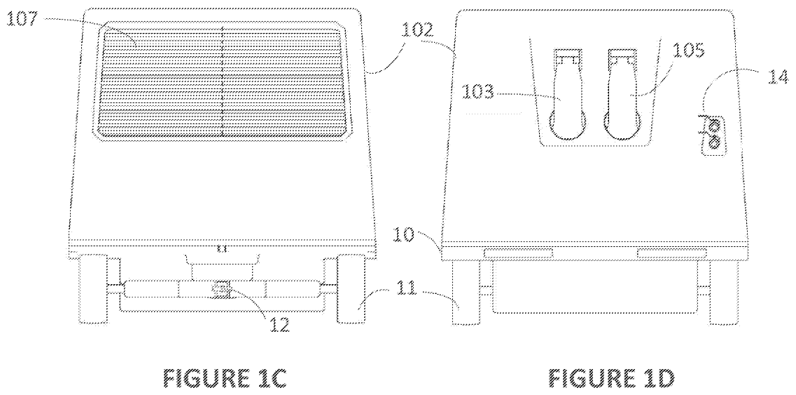

As schematically illustrated in FIG. 1A, a mobile energy storage system 150 can be mobilized (as demonstrated by arrows R and L) between a stationary charging station 110 and a stationary consumer 140 (such as a parked vehicle). During a charging stage the storage system 150 is connected to the stationary charging station 110 to receive a cooled fluid by which to charge the storage system 150. After charging, the storage system 150 is disconnected from the stationary charging station 110 and is mobilized to the consumer 140. The storage system 150 is then connected to the consumer 140, where the storage system 150 is discharged providing thermal energy to the consumer 140. In one embodiment, the consumer 140 is a parked aircraft. In this embodiment, charging can be done during a window of time determined by airport service providers, e.g., to take into account the airport's energy burden schedule and to charge during off-peak hours. Discharging can be done during a window of time determined by airport authorities, e.g., according to landing and takeoff schedules.

A mobile storage system, according to one embodiment of the invention, is schematically illustrated in FIGS. 1B-D. FIG. 1B schematically illustrates a side view of a mobile energy storage system 100, which includes a mobile platform 10, having a propulsion apparatus, such as wheels 11. Any other propulsion apparatus that facilitates mobilization of platform 10 may be used, such as skis (e.g., when moving over snow or ice) or a chain track (e.g., when moving over difficult terrain).

System 100 may include a connecting device 12 such as, a connecting arm, a ball mount or a device configured to receive a ball mount, to enable connecting platform 10 to a transporter (such as an airport operational vehicle) for mobilizing system 100 to a desired location. In some embodiments system 100 may be equipped with its own driving or other transportation unit. System 100 may also include a braking system or mechanism that can be used to lock the propulsion apparatus to prevent system 100 from moving during charging or discharging.

A housing 102, which is placed on or is connected to mobile platform 10, contains an energy storage apparatus 200 (described in detail below). The housing 102 has a fluid inlet 113 and a fluid outlet 115 connected to flexible tubes or sleeves 103 and 105 (shown in FIG. 1D, which a rear view of the system) correspondingly, to allow fluid such as air or a HTF to flow in and out of housing 102. Housing 102 may include vents 107 (shown in FIG. 1C, which shows a front view of the system) to enable any heat generated during operation of energy storage apparatus 200, to escape housing 102.

During a charging stage, cooled HTF is run through an energy storage unit that is part of energy storage apparatus 200. HTF, which typically includes an antifreeze mixture, is designed to achieve a desired (low) temperature without freezing. Solutions that may be used as a HTF, include, for example, ethylene glycol or propylene glycol solutions with water. The cooled HTF flowing through the energy storage unit can cause water or another phase change material (PCM) to freeze, thus creating a thermal energy storage that can later be thawed thus discharging the stored thermal energy.

In some embodiments, the HTF is cooled at an external chiller and is provided to system 100, e.g., via sleeve 103 to inlet 113. For example, HTF cooled by a chiller powered by the electrical grid may be supplied to system 100 during a charging stage. Thus, sleeve 103 may be connected to a chiller or cooled HTF source located in an airport or other building, for providing cooled HTF to system 100, via inlet 113, while charging. The HTF may exit system 100, via outlet 115, after being warmed by the charging, and may be led via sleeve 105 to the chiller or cooled HTF source, to be re-cooled and re-used for charging.

In other embodiments, the HTF used for charging may be cooled by an on-board chiller.

In some embodiments, energy storage apparatus 200 includes a pump (not shown) to facilitate flow of fluids (such as HTF) within the system 100. System 100 may include a portable power source (not shown), such as a chargeable battery, to provide power to the pump and/or possibly to other components of energy storage apparatus 200.

During the charging stage system 100 may be plugged in to the electrical grid (or other suitable power source) via electrical cord 14 (shown in FIG. 1D) to charge the battery and/or to provide power to an on-board chiller and/or components of energy storage apparatus 200, such as pumps and controllers.

Once energy storage apparatus 200 is charged, system 100 can be disconnected from the external chiller and/or from the electrical grid (or other power source) and can be mobilized to the location of a consumer, such as a parked aircraft. System 100 can then be connected to the consumer, and may discharge the energy stored at the charging stage, thereby providing thermal energy to the consumer.

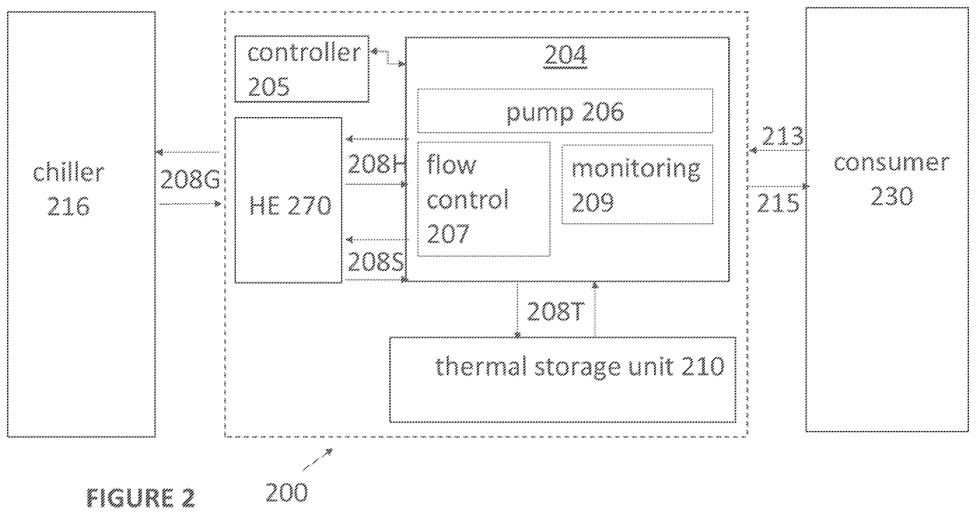

An example of an energy storage apparatus is schematically illustrated in FIG. 2.

The apparatus 200 contains a fluid distribution system 204 which includes components necessary for distributing fluids throughout apparatus 200.

Components of distribution system 204 may include one or more pumps 206, pipes 208 G, H, S and T, flow control mechanisms 207 such as valves, and monitoring components 209 for monitoring, for example, temperatures and flow rates inside apparatus 200.

An external chiller 216, which may be, e.g., an air-cooled or water-cooled chiller, can be connected to apparatus 200 by one or more pipe(s) 208G, to provide cooled HTF to apparatus 200. During a charging stage, cooled HTF is pumped from the chiller 216 via pipes 208G and is directed by fluid distribution system 204 via pipes 208T to energy storage unit 210.

At the end of the charging stage, the temperature of the HTF is increased. The now heated HTF is pumped out of the energy storage unit 210 via pipe(s) 208T and can be directed by fluid distribution system 204 back via pipe(s) 208G to chiller 216 to be cooled again.

The thermal storage unit 210 may include, for example, a cold-energy storage using known techniques, such as encapsulated ice or ice-on-coil or other existing cold-energy storages that make use of a HTF.

The charging stage of the energy storage unit 210 is optionally stopped when a desired temperature is reached, or when a predefined time period has lapsed, or when a predefined amount of energy is stored in unit 210.

A discharging stage may be used to provide thermal energy to a consumer 230 using the energy that was stored in energy storage unit 210 during the charging stage. Connection to a power source, such as the electrical grid and/or connection to a cooled HTF source (such as chiller 216) is typically not required during the discharging stage.

During the discharging stage, HTF is pumped through energy storage unit 210 and is cooled by the stored energy in energy storage unit 210. The cooled HTF may be distributed by distribution system 204 from an outlet of the energy storage unit (e.g., via pipes 208T) to provide thermal energy (e.g., cold-type energy) to consumer 230. The cooled HTF may be directed through pipes 208S into a heat exchanger (HE) 270 where the HTF cools water or another fluid such as air, which is then directed via pipe(s) 208H and via outlet 215 to consumer 230, thus providing air conditioning to consumer 230. Alternatively, cooled HTF may be pumped directly via out let 215 to an AC system of consumer 230 to provide cold-type energy to an AC system of the consumer 230.

After HTF has been used to provide cold-type energy to consumer 230, the temperature of the HTF is increased. The now warm HTF may be recycled into apparatus 200, e.g., via inlet 213 to be pumped into energy storage unit 210 to be cooled again.

In one example, the temperature of the HTF at outlet 215 or when entering heat exchanger 270 is about 5° C. whereas the temperature of the HTF when returning at inlet 213 or when exiting HE 270 is about 10° C.

Chiller 216 may be on-board the mobile energy storage system or may be located at an external location.

In some embodiments, inlet 213 can be used, during the charging stage, to receive cooled HTF from chiller 216 (instead or in addition to pipes 208G) and outlet 215 can be used (instead or in addition to pipes 208G) to output warmed HTF for re-cooling at chiller 216.

As mentioned above, the charging stage of energy storage unit 210, can take place during off-peak hours (hours in which the load on the electrical grid is low) while the discharging stage can occur upon demand, e.g., according to the demands of the vehicle owner, the airport, other vehicle facilities, etc. The discharge process can be stopped when a cutoff temperature of HTF is reached, or when a predefined time period has elapsed, or when a predefined amount of energy is output from energy storage unit 210, or when the demand for cooling at consumer 230 has lowered to a desired level.

Monitoring components 209 optionally feed data to a controller 205 for controlling the cooling/heating process of HTF, e.g., via control of chiller 216, HE 270 and components of the distribution system 204 as described above.

Monitoring components 209 of fluid distribution system 204 may include one or more temperature monitors for monitoring, for example, one or more of: the temperature of HTF before entering the energy storage unit 210 and/or HE 270; the temperature of HTF in any location within the energy storage unit 210; the temperature of HTF after exiting the energy storage unit 210 and/or HE 270; the temperature in one or more pipes of apparatus 200, etc. Monitoring component 209 may also include one or more flow monitors for monitoring the flow of the HTF before entering, inside and after exiting the energy storage unit 210 and/or the flow of HTF before entering, inside and after exiting HE 270.

Energy storage unit 210 may include a cold-energy storage using known techniques, such as encapsulated ice or ice-on-coil or other existing cold-energy storages that make use of HTF.

In some embodiments, a thermal energy storage unit includes a container having an HTF inlet to allow HTF to enter the container, an HTF outlet to allow the HTF to exit the container after being circulated through the container, and capsules containing PCM, the capsules arranged within the container to provide a passage for the HTF to flow over the capsules while circulating through the container.

The container can be configured to be stacked upon another container, enabling to easily use a plurality of thermal energy storage units in parallel or substantially simultaneously. Several storage units can thus be discharged in parallel or substantially simultaneously. Discharging several storage units together enables to provide thermal energy at a high-power output rate that can satisfy high cooling/heating demands, e.g., demands of parked aircrafts.

In one embodiment, an ingoing pipe provides HTF to a plurality of storage units, substantially simultaneously, and an outgoing pipe is used to lead HTF out from the plurality of storage units, after the HTF circulates through a plurality of storage units in parallel.

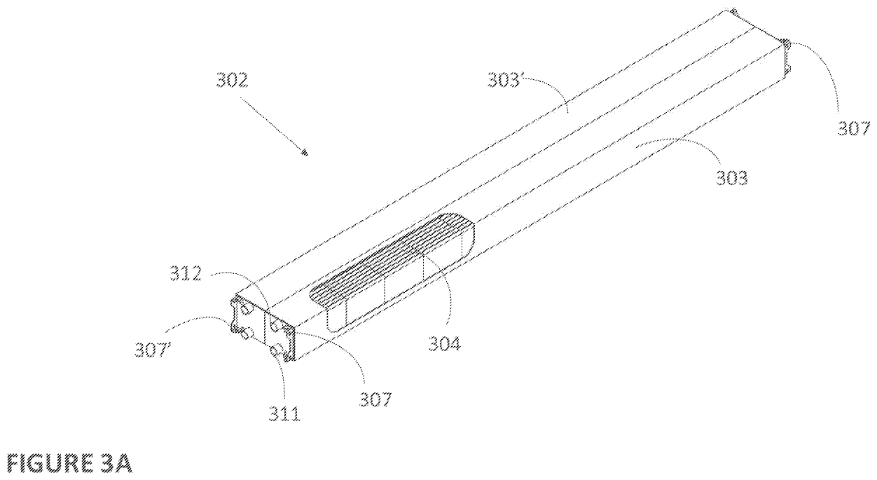

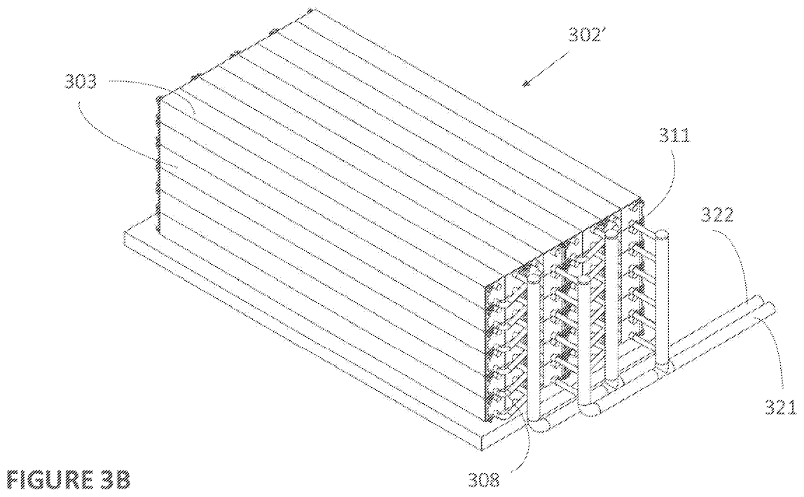

Some examples of energy storage units according to embodiments of the invention, are described in FIGS. 3A-B.

In FIG. 3A, energy storage unit 302 includes at least one container 303 housing capsules 304, each of capsules 304 containing a phase change material (PCM). Container 303 includes an inlet 311 for a HTF to be introduced into container 303 and outlet 312 for the HTF to exit container 303.

The PCM may include, for example, paraffin, water or a mixture of water and eutectic solutions. In some embodiments, the PCM includes water mixed with an ice nucleation agent such as silver iodide or quartz.

When cooled (or heated) to the point of phase change, the material enclosed within each of capsules 304 freezes (or melts). The PCM containing capsules 304 are arranged within container 303 so as to provide a passage for a HTF to flow over the capsules 304. The HTF flowing through the container 303 (typically from inlet 311 to outlet 312) is influenced by the temperature of the PCM within capsules 304 and may be cooled or heated in response to the temperature of the PCM within capsules 304. Inversely, the PCM enclosed within capsules 304 is influenced by the temperature of the HTF flowing over capsules 304. Thus, the PCM within capsules 304 may be cooled/frozen or heated/melted by the HTF flowing over capsules 304.

The capsule containing container 303 is typically designed to enhance mobility and efficient utilization of space. Thus, for example, the container may be relatively small so that its size and weight are practical for mobilizing it from one location to another. For example, container 303 may have a size of 50×50×400 cm to 25×25×400 cm and may hold a volume of about 250-1000 L.

Container 303 may be configured to be stacked upon another container. For example, container 303 may be square or rectangle shaped such that containers can be safely and stably stacked upon each other. Container 303 may also include connectors 307 designed to enable securing one container to another. For example, containers 303′ and 303 placed side by side may be tied together by a cord thread through connectors 307′ and 307 to secure the containers to each other.

As schematically illustrated in FIG. 3B, an energy storage unit 302′ can include several containers 303, fluidly connected to each other via pipes 308 to enable the HTF to flow over the capsules in each of the plurality of containers. In this embodiment, HTF can flow over a larger number of PCM containing capsules substantially simultaneously, thereby enhancing the efficiency of energy transfer between the HTF and PCM within energy storage unit 302′. Several (at least some of) containers 303, each housing PCM containing capsules (not shown), can be stacked on top of each other for efficient space utilization. An ingoing pipe 321 can provide HTF to one or more containers 303 (e.g., via inlet(s) 311), substantially at the same time, and an outgoing pipe 322 may lead HTF from all of the containers 303, out from energy storage unit 302′, e.g., to the consumer.

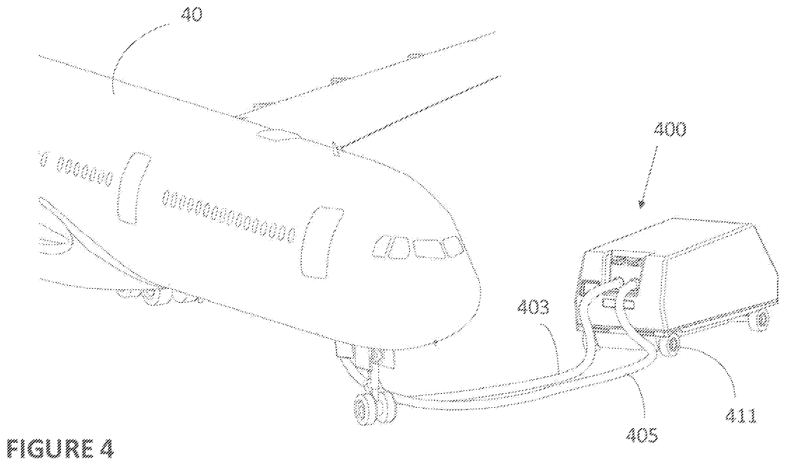

As mentioned above, the consumer can be a parked vehicle, e.g., an aircraft or an AC system of a parked vehicle. As schematically illustrated in FIG. 4, a mobile energy storage system 400 is connected by sleeves 403 and 405 to a parked aircraft 40. System 400 contains a thermal storage unit that was charged at a location away from aircraft 40 and now has stored thermal energy. System 400 is mobilized to the location of aircraft 40 using mobilization apparatus 411 and is positioned in proximity to the aircraft 40 to enable connecting sleeves 403 and 405 to the aircraft, e.g., to the cockpit and to the cabin of the aircraft. HTF is pumped through the charged thermal energy storage unit to be cooled and exits the thermal energy storage unit cold. The cold HTF may then cool another fluid that can be used to cool the aircraft or the cold HTF can be used directly by the aircraft AC system to enable the aircraft AC system to cool the environment in the aircraft without having to use the aircraft engines. In some embodiments, cooled air (or another fluid) is pumped from system 400 to aircraft 40 via sleeve 403 and warm air from the aircraft 40 is returned to system 400 via sleeve 405 to be re-cooled and then pumped again into the aircraft.

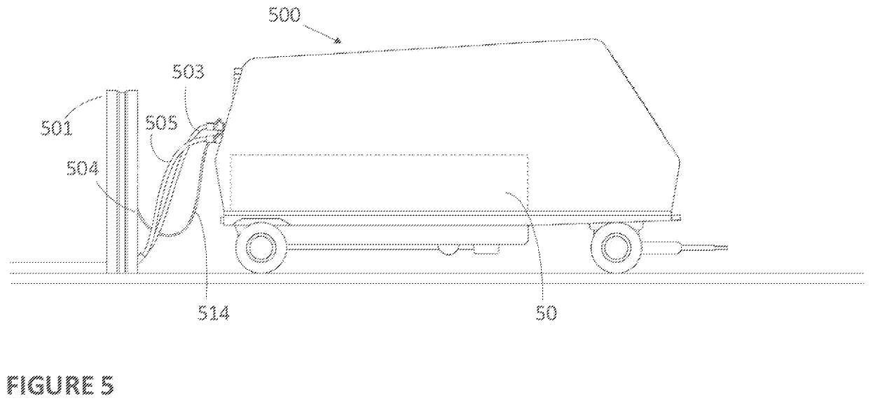

Charging a thermal energy storage unit, according to embodiments of the invention, is schematically illustrated in FIG. 5. A mobile energy storage system 500 is parked near a charging port 501, e.g., at a dedicated charging facility in an airport where charging ports 501 provide connection to a chiller and/or source of cooled HTF and possibly connection to the electric grid. System 500 may be connected to charging port via sleeve 503 for receiving cooled HTF from the chiller and/or source of cooled HTF and via sleeve 505 for returning warmed HTF to the chiller and/or source of cooled HTF for re-cooling (e.g., as described above). The mobile energy storage system 500 can be plugged in to power point 504 via electrical cord 514, to provide power for charging a chargeable portable power source and/or other components of thermal energy storage apparatus 50 (e.g., as described above). The charging can be done at low demand hours and at any location providing a charging point. Alternatively or in addition, charging port 501 may include a solar panel for providing power for charging a chargeable portable power source and/or other components of thermal energy storage apparatus 50.

A dedicated charging facility may provide a central chiller (e.g., a water condensed chiller) to be used for charging, thereby decreasing carbon emission and increasing efficiency.

As described above, once charged, mobile system 500 may be moved to any desired location, thus, parked aircrafts are not restricted to locations that provide AC services, enabling airport authorities flexibility in their decision as to where to locate aircraft parking spots.

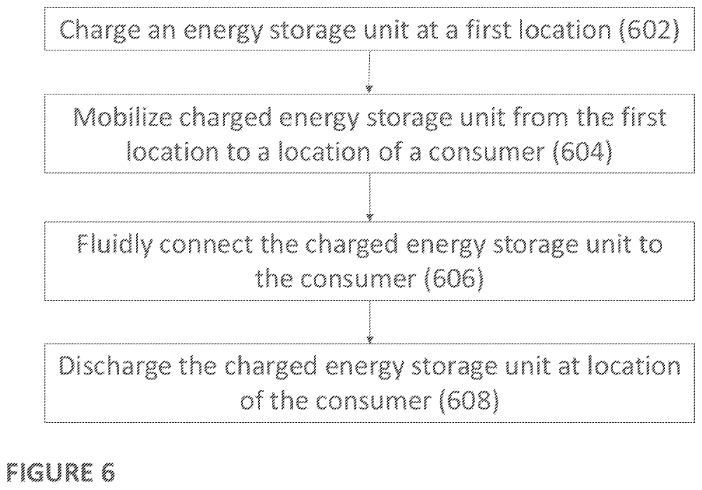

FIG. 6 schematically illustrates a method for supplying thermal energy to a consumer, for example, a parked aircraft. In one embodiment, the method includes charging an energy storage unit at a first location (602), to obtain a charged energy unit. The charged energy storage unit is then mobilized from the first location to a location of a consumer (604). The charged energy unit is then fluidly connected to the consumer (606) and the charged energy storage unit is discharged at the location of the consumer (608), providing the consumer with thermal energy.

As described above, the first location may be in proximity to a cooled HTF source, e.g., at a location of a charging point that provides access to cooled HTF and/or to a high-power source.

Charging the energy storage unit according to embodiments of the invention includes circulating HTF cooled at the first location through the energy storage unit, and discharging the energy storage unit includes circulating HTF through the charged energy storage unit, at the location of the consumer.

In one embodiment, the method includes causing the cooled HTF to flow over PCM containing capsules within the energy storage unit, at the first location, to charge the energy storage unit, and causing the HTF to flow over PCM containing capsules within the charged energy storage unit, at the location of the consumer, to discharge the energy storage unit.

What is claimed is:

1. A mobile energy storage system comprising:
a thermal energy storage unit;
an inlet through which to connect the storage unit to a charging station, during a charging stage;
an outlet by which to connect the storage unit to a consumer, during a discharging stage; and
a mobilization apparatus configured to enable mobilization of the storage unit between the charging station and the consumer.

2. The system of claim 1 comprising a fluid distribution system to introduce a heat transfer fluid (HTF) into the storage unit, circulate the HTF through the storage unit and move the HTF out of the storage unit.

3. The system of claim 2 wherein the fluid distribution system introduces cooled HTF via the inlet to circulate through the storage unit to charge the storage unit with thermal energy.

4. The system of claim 2 wherein the fluid distribution system circulates the HTF through a charged storage unit to discharge the storage unit, thereby cooling the HTF.

5. The system of claim 4 comprising a heat exchanger to accept cooled HTF from the storage unit, to cool air using the cooled HTF and to output cooled air.

6. The system of claim 5 comprising a tube by which to transport the cooled air from the outlet to the consumer.

7. The system of claim 2 wherein the thermal energy storage unit comprises a container, the container comprising:
an HTF inlet to allow the HTF to enter the container;
an HTF outlet to allow the HTF to exit the container after being circulated through the container; and
capsules containing a phase change material (PCM) arranged within the container to provide a passage for the HTF to flow over the capsules while circulating through the container.

8. The system of claim 7 wherein the container is configured to be stacked upon another container.

9. The system of claim 1 comprising a plurality of thermal energy storage units configured to be discharged substantially simultaneously.

10. The system of claim 9 comprising:
an ingoing pipe to provide HTF to the plurality of storage units, substantially simultaneously, and
an outgoing pipe to lead HTF out from the plurality of storage units, after the HTF circulated through a plurality of storage units substantially simultaneously.

11. The system of claim 1 comprising a portable power source to provide power to components of the system.

12. The system of claim 1 wherein the consumer is a parked vehicle.

13. The system of claim 12 wherein the parked vehicle is an aircraft.

14. A method for supplying thermal energy to a consumer, the method comprising:
charging a thermal energy storage unit at a first location, to obtain a charged storage unit;
mobilizing the charged storage unit from the first location to a location of a consumer;
fluidly connecting the charged storage unit to the consumer; and
discharging the charged storage unit at the location of the consumer, providing the consumer with thermal energy.

15. The method of claim 14 comprising:
connecting the storage unit to a charging station at the first location for charging the storage unit; and
disconnecting the storage unit from the charging station before mobilizing the charged storage unit.

16. The method of claim 14 wherein the first location is in proximity to a source of cooled HTF.

17. The method of claim 14 wherein charging the energy storage unit comprises circulating HTF cooled at the first location through the energy storage unit; and wherein discharging the energy storage unit comprises circulating HTF through the charged energy storage unit, at the location of the consumer.

18. The method of claim 14 wherein charging the storage unit comprises circulating HTF over PCM containing capsules within the energy storage unit, the HTF being at a temperature below PCM freezing temperature, thereby causing the PCM to freeze; and wherein discharging the storage unit comprises circulating HTF which is at a temperature above PCM freezing temperature over frozen PCM containing capsules, to cool the HTF.

19. The method of claim 14 wherein the consumer is a parked aircraft.

20. The method of claim 19 comprising:
charging the storage unit during a window of time determined by airport service providers; and
discharging the storage unit during a window of time determined by airport authorities.
